(19) United States
(12) Patent Application Publication
(10) Pub. No.: US 2007/0069720 A1
(43) Pub. Date: Mar. 29, 2007

(54) Material characterization with model based sensors

(76) Inventors: Neil J. Goldfine, Newton, MA (US); Mark D. Windoloski, Chelmsford, MA (US); David C. Grundy, Reading, MA (US); Yanko K. Sheiretov, Waltham, MA (US); Darrell E. Schlicker, Watertown, MA (US); Andrew P. Washabaugh, Chula Vista, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/229,844

(22) Filed: Sep. 19, 2005

Related U.S. Application Data
(60) Provisional application No. 60/610,817, filed on Sep. 17, 2004.

(51) Int. Cl. G01N 27/82

(52) U.S. Cl. 324/240

(57) ABSTRACT

Nondestructive material condition monitoring and assessment is accomplished by placing, mounting, or scanning magnetic and electric field sensors and sensor arrays over material surfaces. The material condition can be inferred directly from material property estimates, such as the magnetic permeability, dielectric permittivity, electrical property, or thickness, or from a correlation with these properties. Hidden cracks in multiple layer structures in the presence of fasteners are detected by combining multiple frequency magnetic field measurements and comparing the result to characteristic signature responses. The threshold value for indicating a crack is adjusted based on a high frequency measurement that accounts for fastener type. The condition of engine disk slot is determined without removal of the disk from the engine by placing near the disk a fixture that contains a sensor for scanning through the slot and means for recording position within the slot. Inflatable support structures can be placed behind the sensor to improve and a guide can be used to align sensor with the slot and for rotating the disk. The condition of an interface between a conducting substrate and a coating is assessed by placing a magnetic field sensor on the opposite side of the substrate from the coating and monitoring at least one model parameter for the material system, with the model parameter correlated to the interfacial condition. The model parameter is typically a magnetic permeability that reflects the residual stress at the interface. Sensors embedded between material layers are protected from damage by placing shims on the faying surface. After determining the areas to be monitored and the areas likely to cause sensor damage, a shim thickness is determined and is then placed in at least one area not being monitored by a sensor. The condition of a test fluid is assessed through a dielectric sensor containing a contaminant-sensitive material layer. The properties of the layer are monitored with the dielectric sensor and correlated to contaminant level.

### RELATED APPLICATION

This application claims the benefit of U.S. Provisional Application No. 60/610,817 filed Sep. 17, 2004, the entire teachings of which are incorporated herein by reference.

### GOVERNMENT SUPPORT

The invention was supported, in whole or in part, by Contract Number DTFA03-01-C-00024 from the FAA and by Contract Number N68335-03-C-0123 from the Department of the Air Force. The Government has certain rights in the invention.

### BACKGROUND OF THE INVENTION

The technical field of this invention is that of nondestructive materials characterization, particularly quantitative, model-based characterization of surface, near-surface, and bulk material condition for flat and curved parts or components. Characterization of bulk material condition includes (1) measurement of changes in material state, i.e., degradation/damage caused by fatigue damage, creep damage, thermal exposure, or plastic deformation; (2) assessment of residual stresses and applied loads; and (3) assessment of processing-related conditions, for example from aggressive grinding, shot peening, roll burnishing, thermal-spray coating, welding or heat treatment. It also includes measurements characterizing the material, such as alloy type, and material states, such as porosity and temperature. Characterization of surface and near-surface conditions includes measurements of surface roughness, displacement or changes in relative position, coating thickness, temperature and coating condition. Each of these includes detection of electromagnetic property changes associated with either microstructural and/or compositional changes, or electronic structure (e.g., Fermi surface) or magnetic structure (e.g., domain orientation) changes, or with single or multiple cracks, cracks or stress variations in magnitude, orientation or distribution. Spatially periodic field eddy-current sensors have been used to measure foil thickness, characterize coatings, and measure porosity, as well as to measure property profiles as a function of depth into a part, as disclosed in U.S. Pat. Nos. 5,015,951 and 5,453,689.

Common methods for measuring the material properties use interrogating fields, such as electric, magnetic, thermal or acoustic fields. The type of field to be used depends upon on the nominal properties of the test material and the condition of interest, such as the depth and location of any features or defects. For relatively complicated heterogeneous materials, such as layered media, each layer typically has different properties so that multiple methods are used to characterize the entire material. However, when successively applying each method, there is no guarantee that each sensor is placed at the same distance to the surface or that the same material region is being tested with each method without careful registration of each sensor.

A common inspection technique, termed conventional eddy-current sensing involves the excitation of a conducting winding, the primary, with an electric current source of prescribed frequency. This produces a time-varying magnetic field, which in turn is detected with a sensing winding, the secondary. The spatial distribution of the magnetic field and the field measured by the secondary is influenced by the proximity and physical properties (electrical conductivity and magnetic permeability) of nearby materials. When the sensor is intentionally placed in close proximity to a test material, the physical properties of the material can be deduced from measurements of the impedance between the primary and secondary windings. Traditionally, scanning of eddy-current sensors across the material surface is then used to detect flaws, such as cracks.

As one particular example inspection application, eddy-current sensing with differential sliding probes is often used to inspect for cracks around fasteners used in attaching material layers in a lap joint. The type of fastener being inspected and the electrical conductivity between the fastener and adjoining skin can also have a significant impact on the eddy-current responses. Another method of assessing the condition of materials on one or both sides of an interface is to place sensors between the layers. Then, care must be taken to prevent damage to the sensor. For example, in some situations, resistance gages can be placed between the material layers in a lap joint in order to monitor crack growth rates. However, the use of such gages requires relatively thick regions of the material layers to be milled out, which impact the performance of the joint and can lead to undesired fatigue damage. Similarly, in many coated components it is desirable to monitor the condition of the interface between the coating and a substrate material. The presence of disbonds or lack of adhesion between the coating and the substrate can impact the performance of the component.

### SUMMARY OF THE INVENTION

Aspects of the methods described herein involve nondestructive condition monitoring of materials. These conditions include stress, damage, health, and the presence of foreign matter. The material condition is typically assessed through correlations with independent estimates of material properties, such as electrical conductivity, dielectric permittivity, magnetic permeability, and effective layer thicknesses.

In an embodiment, hidden cracks in a layered material and near fasteners are detected by scanning a sensor over the test material surface and acquiring data at multiple excitation frequencies. Often, the material layers are metal, such as an aircraft skin, so that the sensor can use a magnetic field to interrogate the material and cracks form beneath the exposed surface of the material. A high frequency measurement is performed to determine the material properties above or shallower than the crack, which can include the sensor lift-off from the material surface, the fastener type, and the quality of the conduction between the fastener and the test material layers. In particular, anodized fasteners tend to have poor conductivity between the fastener and the skin layers while alodine fasteners can have a range of conductivity, from poor to good, depending upon the quality of the fastener installation. A lower frequency measurement provides sensitivity to the presence and properties of a crack. Taking the difference between the high and low frequency responses tends to highlight the response associated with the crack. To improve the crack detection reliability, the net response is filtered through comparison to a reference or signature scan for a crack, which is in turn compared to a threshold value to determine the likelihood that a crack is present. The high frequency response can also be used to adjust the threshold value, again to increase the reliability of crack detection. In an embodiment, the sensor has at least two rows of parallel sensing elements to facilitate imaging over wider areas during the inspection. Each row of sensing elements is positioned to either side of a linear drive conductor which provides different levels of sensitivity to cracks on either side of the fastener. The responses can be combined together to create a single response image that can show the presence of cracks on either side of the fastener. To further improve the crack detection reliability, in another embodiment, a library of signature responses, determined empirically or from computer simulation, are used and the lift-off is used to select or determine an appropriate signature response for the filtering operation.

In one embodiment, engine disk slots are inspected without having to remove the disk itself from the engine. This involves removing the blades from the engine disk and mounting near the disk a fixture that contains a flexible sensor or sensor array that can be inserted into the disk slot and scanned over the slot material surface. Since these disks are commonly superalloy metals, the sensor uses a magnetic field, like an eddy-current sensor, to assess the material condition. Typically, an encoder or some other means is used to monitor sensor position inside the slot so that the measured responses can be readily formed into an image and locations of any suspect areas in the slot can be readily determined. In an embodiment, a pressurizable support such as a balloon is placed behind the sensor and expanded after the sensor is in the slot in order to bring the sensor closer to the material surface and to reduce mechanical stresses on the sensor itself from the insertion process. In another embodiment, the fixture also contains a guide that can be actuated to rotate the disk or even pass into a second slot to maintain the alignment of the sensor with the slot and the rotation rate. In yet another embodiment, the sensor response is converted into effective material properties, such as an electrical conductivity or lift-off. When a lift-off is determined, the lift-off can be used to determine the quality of the inspection, for example by ensuring that it is within reasonable bounds.

In another embodiment, the interfacial condition between a coating and a conducting substrate. This is accomplished by placing a magnetic field or eddy-current sensor on the opposite side of the substrate from the coating and converting measured sensor responses into at least one model parameter that is correlated with the interfacial condition. In an embodiment, the interfacial condition is the residual stress. In another, the model parameter is magnetic permeability. In other embodiments, the coating is a metal bond coat which has a magnetic relative permeability greater than 1 or the bond coat properties are selected to enhance sensitivity to the residual stress between an insulating outer coating or top coat and the substrate. In an embodiment, a model is used to estimate multiple parameters for the coating and substrate. One embodiment has the sensor scanned along the outside surface of an aircraft engine, which facilitates the creation of images of property or parameter values that can be used to detect damage, such as a disbond. Another embodiment has the sensor mounted to an outside surface of the engine so that the sensor remains in place during service and can be used to monitor wear or detect damage on the inside of the engine. Furthermore, multiple frequencies can be used with precomputed databases of responses to determine multiple properties for the material layers, including magnetic permeability of one of the material layers and sensor lift-off.

In yet another embodiment, sensors embedded between material layers are protected from damage by placing shims or spacer materials between the material layers. This involves determining areas to be monitored by the sensors and areas on the faying surface likely to cause damage to the sensor, determining a minimal thickness for a spacer material to prevent sensor damage, and placing at least one shim in an area not being monitored by a sensor. Typically, shims are placed in multiple areas in order to ensure uniform mechanical loading across the faying surface. In an embodiment, the areas likely to result in damage are around cold-worked fastener holes. In particular embodiments, the minimum shim thickness is the sensor thickness or the sensor thickness added to the peak surface deformation on the areas likely to result in damage.

Another embodiment is aimed at the detection of contaminants or other foreign matter by using a material sensitive layer as part of a dielectric sensor that provides responses at multiple effective spatial wavelengths within the same sensor footprint. Associated with each spatial wavelength is an effective penetration depth for the interrogating electric field into the material. The material sensitive layer has at least one property, such as a dielectric constant, electrical conductivity, or thickness, which changes in response to the contaminant. This property and changes in the property are monitored with the dielectric sensor are correlated to the presence of the contaminant. In another embodiment, at least two properties are monitored by using two or more field penetration depths into the material. In an embodiment, the contaminant is biological and a reagent is used to alter the measured properties. In another, a biological fluid is monitored and the contaminant is the presence of unhealthy cells. A chemical reagent may also be used to alter or enhance the sensitivity of the sensor to the presence of the unhealthy cells. In another embodiment the contaminant may also pose a chemical threat.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a drawing of a spatially periodic field eddy-current sensor.

FIG. 2 shows a plan view of sensor array with a single primary winding and an array of sensing elements with connections to each individual element.

FIG. 3 shows a representative measurement grid relating the magnitude and phase of the sensor terminal impedance to the lift-off and magnetic permeability.

FIG. 4 shows a representative measurement grid relating the magnitude and phase of the sensor terminal impedance to the lift-off and electrical conductivity.

FIG. 5 shows a layout for a single turn Cartesian geometry GMR magnetomer.

FIG. 6 shows a representative single wavelength interdigitated electrode dielectrometer with spatially periodic driven and sensing electrodes of wavelength λ that can measure dielectric properties of the adjacent material.

FIG. 7 shows an illustration comparing the size of an array element with the fastener and the corresponding crack response image around the fastener.

FIG. 8 shows the peak transinductance magnitude values from the 15.8 kHz responses from both the anodized and the alodined rivets.

FIG. 9 shows the ratios of ahat values from the alodine rivets to the corresponding ahat values from the anodized rivets versus the corresponding ratios of the peak magnitude values.

FIG. 10 is a drawing of a sensor over a coating on a substrate.

FIG. 11 shows an image of a high frequency measurement on a coated material.

FIG. 12 shows an image of a low frequency measurement on a coated material.

FIG. 13 is a drawing of a coating on a substrate with a sensor placed on the opposite side of the substrate from the coating.

FIG. 14 is a rendering of a four hole lap joint with MWM-Arrays mounted along one row of fastener holes.

FIG. 15 is a schematic drawing of a single panel for a 10 hole lap joint test specimen.

FIG. 16 shows a schematic of the MWM-Arrays and the test row of holes as viewed from the top surface. The approximate cycle number when each sense element started to indicate crack growth is also indicated.

FIG. 17 shows a plot of crack growth history across the test row of fasteners.

FIG. 18 shows a plot of the data for each sense element channel monitoring the test row of fasteners.

FIG. 19 shows a plot of the data for each sense element during the load ramps.

FIG. 20 shows a plot of the adjusted lift-off data as the crack propagates from the right hand side of the central hole.

FIG. 21 shows a plot of the adjusted conductivity data as the crack propagates from the right hand side of the central hole (hole 3 in FIG. 16).

FIG. 22 is a drawing of a probe and rotation mechanism for inspection of engine disk slots.

### DETAILED DESCRIPTION OF PREFERRED EMBODIMENTS

A description of preferred embodiments of the invention follows.

This invention is particularly directed toward the use of sensors whose response can be accurately modeled when proximate to a test material. Measurements of the sensor response are then converted into estimates of the effective properties of the test material, such as electrical conductivity, magnetic permeability, dielectric permittivity, and the thicknesses of material layers. The lift-off or sensor proximity to the test material surface is another layer thickness that can be estimated.

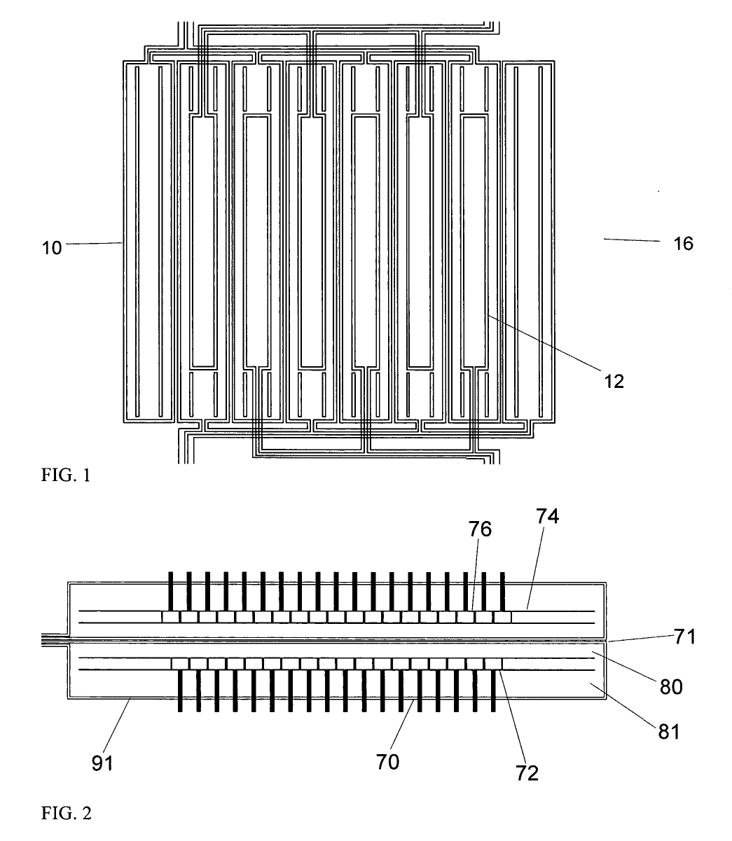

An example magnetic field sensor that operates in the magnetoquasistatic regime is shown in FIG. 1. This meandering winding magnetometer (MWM®) is a “planar,” conformable eddy-current sensor that was designed to support quantitative and autonomous data interpretation methods. The sensor 16 is described in U.S. Pat. Nos. 5,453,689, 5,793,206, 6,188,218, 6,657,429 and U.S. patent application Ser. No. 09/666,524 filed on Sep. 20, 2000 and Ser. No. 09/633,905 filed Aug. 4, 2003, the entire teachings of which are incorporated herein by reference. The sensor includes a primary winding 10 having extended portions for creating the magnetic field and secondary windings 12 within the primary winding for sensing the response. The primary winding is fabricated in a spatially periodic pattern with the dimension of the spatial periodicity termed the spatial wavelength λ. A current is applied to the primary winding to create a magnetic field and the response of the MUT to the magnetic field is determined through the voltage measured at the terminals of the secondary windings. This geometry creates a magnetic field distribution similar to that of a single meandering primary winding. A single element sensor has all of the sensing elements connected together. The net magnetic vector potential produced by the current in the primary can be accurately modeled as a Fourier series summation of spatial sinusoids, with the dominant mode having the spatial wavelength λ. For an MWM-Array, the responses from individual or combinations of the secondary windings can be used to provide a plurality of sense signals for a single primary winding construct as described in U.S. Pat. No. 5,793,206 and Re. 36,986.

The MWM-Arrays typically have one or more drive windings, possibly a single rectangle, and multiple sensing elements for inspecting the test material. Some of the motivation for the use of multiple sensing elements is to increase the spatial resolution of the material being characterized without loss of coverage, to add additional information for use in the estimation of multiple unknown material properties, and to cover large inspection areas in a faster time. Example scanning sensor arrays are described in detail in U.S. Pat. No. 6,784,662. FIG. 2 shows a schematic view of a permanently mounted seven-element array. Connections are made to each of the individual secondary elements 61. Dummy elements 63 are placed on the outside meanders of the primary 65. As described in U.S. Pat. No. 6,188,218, the secondaries are set back from the primary winding connectors 67 and the gap between the leads to the secondary elements are minimized.

An efficient method for converting the response of the MWM sensor into material or geometric properties is to use grid measurement methods. These methods map two known values, such as the magnitude and phase or real and imaginary parts of the sensor impedance, into the properties to be determined and provide for a real-time measurement capability. The measurement grids are two-dimensional databases that can be visualized as “grids” that relate two measured parameters to two unknowns, such as the magnetic permeability (or electrical conductivity) and lift-off (where lift-off is defined as the proximity of the MUT to the plane of the MWM windings). For the characterization of coatings or surface layer properties, three- (or more)-dimensional versions of the measurement grids called lattices and hypercubes, respectively, can be used. Alternatively, the surface layer parameters can be determined from numerical algorithms that minimize the least-squares error between the measurements and the predicted responses from the sensor, or by intelligent interpolation search methods within the grids, lattices or hypercubes.

An advantage of the measurement grid method is that it allows for near real-time measurements of the absolute electrical properties of the material and geometric parameters of interest. The database of the sensor responses can be generated prior to the data acquisition on the part itself, so that only table lookup and interpolation operations, which are relatively fast, needs to be performed after measurement data is acquired. Furthermore, grids can be generated for the individual elements in an array so that each individual element can be lift-off compensated to provide absolute property measurements, such as the electrical conductivity. This again reduces the need for extensive calibration standards. In contrast, conventional eddy-current methods that use empirical correlation tables that relate the amplitude and phase of a lift-off compensated signal to parameters or properties of interest, such as crack size or hardness, require extensive calibrations using standards and instrument preparation.

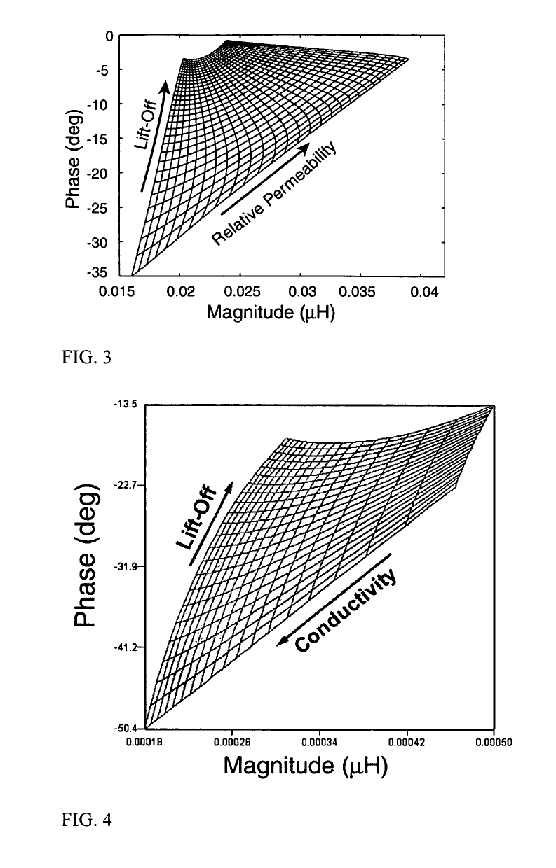

For ferromagnetic materials, such as most steels, a measurement grid can provide a conversion of raw data to magnetic permeability and lift-off. A representative measurement grid for ferromagnetic materials is illustrated in FIG. 3. A representative measurement grid for a low-conductivity nonmagnetic alloy (e.g., titanium alloys, some superalloys, and austenitic stainless steels) is illustrated in FIG. 4. For coated materials, such as cadmium and cadmium alloys on steels, the properties of the coatings can be incorporated into the model response for the sensor so that the measurement grid accurately reflects, for example, the permeability variations of substrate material with stress and the lift-off. Lattices and hypercubes can be used to include variations in coating properties (thickness, conductivity, permeability), over the imaging region of interest. The variation in the coating can be corrected at each point in the image to improve the measurement of permeability in the substrate for the purpose of imaging stresses. The effective property can also be a layer thickness, which is particularly suitable for coated systems. The effective property could also be some other estimated damage state, such as the dimension of a flaw or some indication of thermal damage for the material condition.

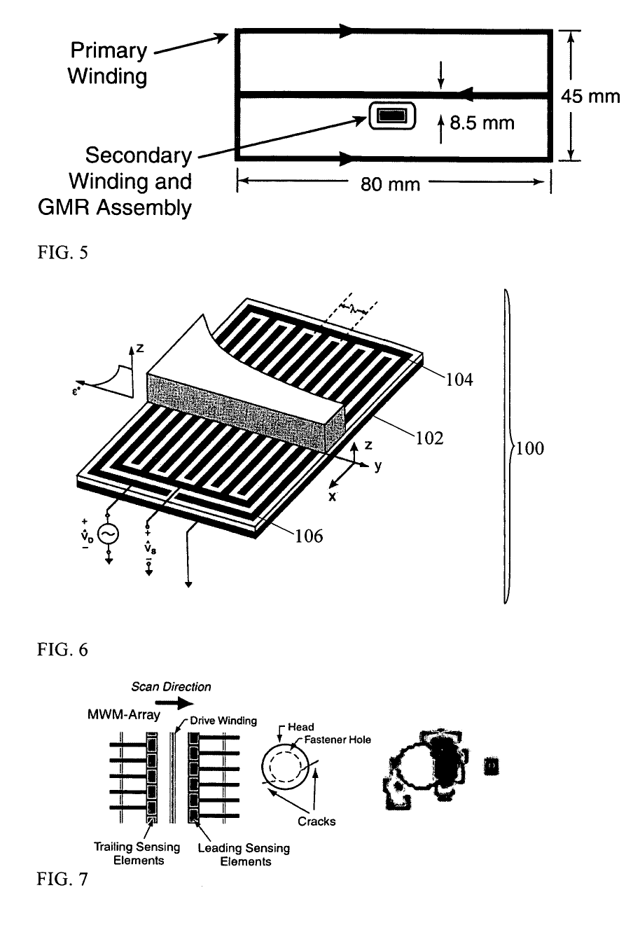

In addition to inductive coils, other types of sensing elements, such as Hall effect sensors, magnetoresistive sensors, SQUIDS, Barkhausen noise sensors, and giant magnetoresistive (GMR) devices, can also be used for the measurements. The use of GMR sensors for characterization of materials is described in more detail in U.S. patent application Ser. No. 10/045,650, filed Nov. 8, 2001, the entire teachings of which are incorporated herein by reference. An example rectangular or Cartesian-geometry GMR-based magnetometer is illustrated in FIG. 5. Conventional eddy-current sensors are effective at examining near surface properties of materials but have a limited capability to examine deep material property variations. GMR sensors respond to magnetic fields directly, rather than through an induced response on sensing coils, which permits operation at low frequencies, even DC, and deeper penetration of the magnetic fields into the test material. The GMR sensors can be used in place of sensing coils, conventional eddy-current drive coils, or sensor arrays. Thus, the GMR-based sensors can be considered an extension of conventional eddy-current technology that provides a greater depth of sensitivity to hidden features and are not deleteriously affected by the presence of hidden air gaps or delaminations.

For insulating or weakly conducting materials such as fiberglass composites, capacitive or dielectric sensors can be used. The sensors are the electromagnetic dual to the inductive sensors, with electric fields taking the place of magnetic fields for inspecting the materials and can be used to monitor stress or temperature, moisture content or contamination or overload of fatigue in adhesives, epoxies, glass, oil, plastics and in single or multiple layered media. Here the conductivity and dielectric constant or complex permittivity and layer thicknesses are measured using the same methods as for magnetic field sensing, except that the sensors operate in the electroquasistatic regime. In one such electric field method multiple layers of material are added to a base material with each layer sensitive to different chemicals or biological materials. These different layers may be sensitive to contaminants, biological agents, reagents, or chemical threats and can provide a change in dielectric properties to any of these other materials. By exposing such selective or sensitive material layers to a test environment, such as a gas, liquid, or fluid, the property change in the material layer can be monitored and use to assess the presence of unhealthy cells, particulate matter, or other agents. The sensitivity of the material layer may also be altered by adding other reagents.

A representative single sided sensor geometry is shown in FIG. 6. The application of a sinusoidally time varying potential of angular frequency ω=2πf results in the flow of a terminal current, whose magnitude and phase is dependent on the complex permittivity of the material. The capacitive sensor 100 has interdigitated electrodes as presented in U.S. Pat. Nos. 4,814,690, 6,380,747, 6,486,673 and 6,781,387 and in U.S. patent application Ser. No. 10/040,797, filed Jan. 7, 2002, the entire teachings of which are hereby incorporated by reference. This sensor 102 utilizes a pair of interdigitated electrodes 104 and 106 to produce a spatially periodic electric field. The electrodes are adjacent to the material of interest with an insulating substrate and a ground plane on the other side of the substrate. One of the two electrodes, 104, is driven with a sinusoidally varying voltage v_{D} while the other, 106, is connected to a high-impedance buffer used to measure the magnitude and phase of the floating potential v_{S} or to a virtually grounded amplifier to measure the magnitude and phase of the terminal current I. The periodicity of the electrode structure is denoted by the spatial wavelength λ=2π/k, where k is the wavenumber.

These sensors can be used in an embodiment of this invention as part of a method for characterizing hidden damage beneath material layers, such as cracks and flaws in aircraft skins. In particular, the fasteners used in attaching material layers in a lap joint typically have a significant impact on the response of a sensor scanned over the surface to flaws near the fastener hole. In many commercial aircraft, prior to the early to mid-1990's, anodized aluminum fasteners were used, where the electrical conductivity between the fastener and the skin material was relatively poor. Alodined rivets were then developed and transitioned into use which provide greater electrical continuity between the fastener and the skin and provide better performance against lighting strikes. However, this transition to different fastener types can compromise inspection methods for hidden flaws under the fastener head or emanating from the fastener hole that rely on poor electrical contact between the fastener and skin.

Here, a multiple frequency measurement method described previously in U.S. Pat. No. 6,784,662 and U.S. patent application Ser. No. 10/345,883, filed Jan. 15, 2003, the entire contents of which are incorporated herein by reference, for detecting flaws around fasteners is extended to improve the inspection around alodined fasteners. In this case, the signature response for the flaw is scaled using a response to a fastener feature. The scale of the response and threshold for an indication is based on a feature such as a peak height so that alodined fastener responses are made to look essentially equivalent to anodized fastener responses. This also provides a mechanism for recognizing the likelihood that the fastener is an alodined fastener, realizing that the response from many alodined fasteners, which may not have been installed properly, may be similar to the responses from anodized fastener.

A common layered geometry attached by fasteners is used for commercial aircraft lap joints such as the Boeing 727 and 737 and Airbus A320. These lapjoints typically have a thick (e.g., 0.080-in.) first layer (including the doubler thickness) and 0.040-in. second layer. Comer cracks typically form at the fastener hole in the lower layer. Note that doublers are often used on some aircraft so that the flaw is either in the 0.040-in. second layer on, for aircraft with doublers, in the 3^{rd} layer. FIG. 7 shows an illustration of a sensor array being scanned over a fastener. For illustration purposes, the hidden cracks are also indicated but no cracks would normally be visible from the top view. FIG. 7 also shows the nominal response image that would be obtained from the sensor array after combining the responses from each sense element at each frequency.

For FIG. 7, the spatial wavelength of the MWM-Array drive was selected to provide the required depth of sensitivity to cracks in the lower layer. The orientation of the MWM-Array drive was selected to maximize sensitivity to cracks propagating towards neighboring fasteners in the same row, while minimizing the interference with the fastener head. The MWM-Array used to produce this data has two rows of rectangular sensing elements, a lead row and a trailing row, with a drive winding passing between them. Note that in this design, a sensing element exhibits the greatest sensitivity to a crack when the drive winding is directly above the crack and the sensing element is not above the fastener head. Consequently, as the array is scanned across the specimen, the leading row of sensing elements is especially sensitive to cracks on the far side of the fastener, while the trailing row of elements is especially sensitive to cracks on the near side of the fastener. The resulting images from the two rows of sensing elements can then be summed to provide accurate crack imaging for both sides of the fasteners.

In this example, the scans were conducted at two frequencies, 15.8 kHz and 6.3 kHz. The 15.8 kHz data is sensitive to ˜0.060 in. into the lap joint, while the 6.3 kHz data is sensitive beyond 0.080 in. The location of each fastener was determined from the 15.8 kHz data and a circle was drawn on the image to indicate the location of the fastener. Then a subtraction of data at 15.8 kHz from data at 6.3 kHz was performed to remove the effects of the near surface region (e.g., the interference from the fastener head). The resulting data can then be filtered using a shape matching filter to known crack signatures, as described previously in U.S. Pat. No. 6,784,662 and U.S. patent application Ser. No. 10/345,883, filed Jan. 15, 2003. The resulting image shows a clear indication of crack locations. This method can be extended to use three or more frequencies to improve detection of the cracks and to provide information about the crack sizes. The data used for the subtraction between frequencies and shape filtering can be an effective property, such as an effective conductivity and/or an effective liftoff obtained from a measurement grid, the complex transimpedance between the drive and sense elements, or a portion of the transimpedance, such as the real part, imaginary part, magnitude and/or phase. Of course, for other layer thicknesses or material types different excitation frequencies can be selected.

The MWM-Array images can be produced with automatic or manual scanners. Manual scans using a simple position encoder (rolling along the surface) produce similar results to automated scanners. This manual scanning provides a relatively low cost, high throughput inspection system that requires minimal training and setup time. To produce the images, a simple infinite half space model was used to represent the aluminum component. Improved results could be obtained by using a more accurate model that better represents the layered geometry of the test material and the fasteners. The elimination of automated scanners could provide a significant advantage by reducing setup time and logistics support, as well as capital cost. Alternatively, an automated scanner could be used to improve image resolution by performing repeated scans with a spatial offset of ½ a sensing element width, or to improve signal to noise ratio through averaging of repeated images.

It is anticipated that smaller sensing elements could also improve image resolution and allow determination of crack orientation and length. Although it is unlikely that higher resolution arrays will be able to determine the length of very small cracks (less than 0.050 in.) by imaging, it may well be possible to provide sufficient resolution to measure the length of larger cracks within an image. Even without using smaller sense elements, information on the orientation of cracks that propagate from both sides of the fasteners is available.

Typically only a calibration in air is performed, i.e., no crack standards were used. In practice, however, it may be desirable to use crack standards to set crack detection thresholds and adjust the color scale on the MWM-Array images for presentation to the operator. It is also recommended that performance checks be conducted after initial set up for depot and field measurements.

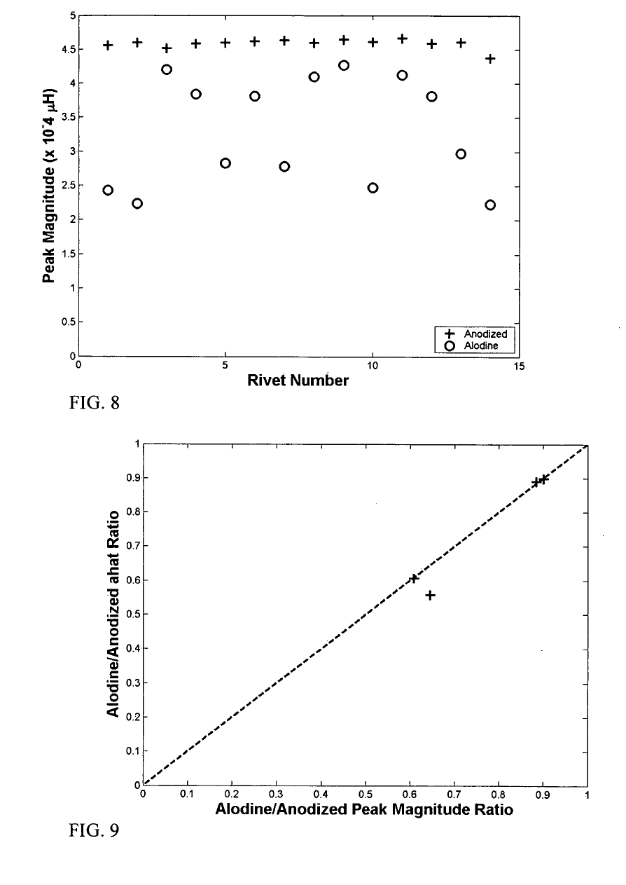

When alodine fasteners are used, the threshold value can be adjusted to account for variations in the electrical conduction between the fastener and the panel layers. Both anodized and alodine fasteners produce an increase in the magnitude of the transinductance, |L|, as the sensor is scanned over the fastener. As seen in FIG. 8 the peak value of |L| (for the sensing element scanning over the center of the fastener) is generally lower for alodine fasteners than for anodized. The ahat (crack response) values from the alodine-fasteners are also reduced which makes it necessary to reduce the crack detection threshold. Therefore, in order to avoid increasing the false-call rate it is necessary to be able to adjust the crack response (ahat) threshold appropriately for the alodine fasteners. This requires not only the capability to identify the fastener type, but also to determine the appropriate threshold for each alodine fastener. Fastener-type identification can be accomplished by looking at the high frequency response from the fasteners. As shown in FIG. 8, the peak value of |L| exhibits relatively little fastener-to-fastener variation for anodized fasteners while those from the alodine rivets are more scattered but are generally less than anodized-rivet values. Thus, alodine fasteners can be distinguished from anodized fasteners. Then, for alodine fasteners, the output from the crack-detection shape-filter algorithm can be scaled in such a way that cracks of the same size produce that same filtered response for alodine and anodized fasteners. The appropriate scale factor for achieving this result is the ratio of the average anodized-fastener peak value of |L| to the alodyne-fastener peak value of |L|. FIG. 9 provides a plot of the ratios of ahat values from the alodine-rivets to the corresponding ahat values from the anodized-rivets versus the corresponding ratios of the peak magnitude values. There is a good correlation between these ratios which enables the scaling of the ahat values by the peak magnitude for both anodized and alodine rivets and thereby removes the variation with fastener type. The adjustment of the threshold values can be based on the complex transimpedance or on an effective property, such as an effective conductivity and/or an effective liftoff obtained from a measurement grid.

In one aspect of this invention an electromagnetic sensor is placed in proximity to a material and a parameter is calculated from the sensor response. This factor is then used to adjust the threshold of detection that is applied to a second parameter. In the above fastener example, the first parameter would be the peak value of the transinductance that relates anodized to alodined fasteners and enables setting of a detection threshold while the second parameter is the crack response. In a related embodiment scans are made of a feature such as a crack at a fastener and features of said scans are stored as signatures. These signature features may be extracted from the scans or, if appropriate, the entire scan itself. The scans and associated signatures can result from a series of empirical measurements or computer simulations for different values of a selected parameter, such as lift-off, to form a signature library. Again, for the fastener example, the different lift-offs could represent varying thicknesses of paint layers on the surface of the component. Then, when applied to an inspection of an actual part, the actual sensor response is filtered using the extracted signature, where the extracted signature is selected from a signature library using the parameter of the sensor response, e.g., lift-off or a function of lift-off, to select the appropriate signature to use in the filter. A representative filter is one that matches the shape of the scan response to a signature in the library. In another embodiment, more that one parameter is used to determine the appropriate reference response for the signature library. In another example embodiment different response shapes are selected for different lift-offs and the threshold is selected based on a parameter of the sensor related to a material property, such as an alodine versus anodized fastener response parameter.

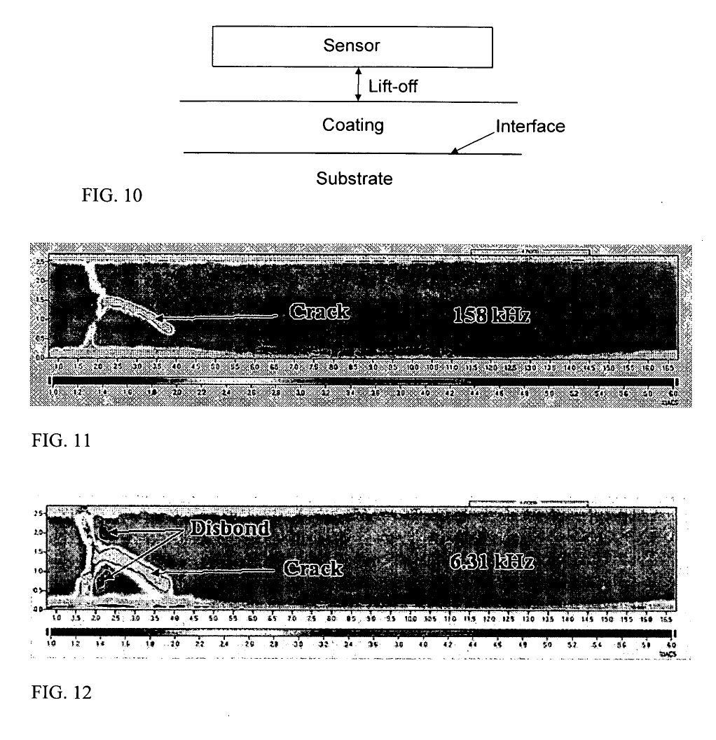

Another embodiment of this invention is the use of single sided sensors for characterization of coating properties. An example is the characterization of Thermal Barrier Coatings (TBC) used in engine components. This is described as part of U.S. patent application Ser. No. 11/036,780, dated Jan. 15, 2005, the entire contents of which are incorporated herein by reference. In reference to FIG. 10, the coating in this case is an insulating ceramic and the substrate is a metal, which may or may not also have a metallic bond coat. The dielectric sensors permit estimation of the dielectric permittivity and hence the porosity of the insulating ceramic coatings placed on the turbine blade or engine materials. Versions of these can also be made for monitoring of areas exposed to high temperatures, such as inside or nearby an engine. Specifically, for dielectric sensors, there may be coatable versions, where the outside surface or some areas of the sensors are coated with a ceramic. In another embodiment, the coatings themselves may be used to form the electrodes for the sensor. For example, for low frequency capacitive sensor operation, the electrodes do not have to be as highly conducting as, for example, with inductive sensor windings. In one embodiment a slightly conducting coating may be used for the electrodes; note water is conducting enough, so water-based coatings or other such coatings may be used for the electrodes. Moisture ingress into the coating, or exposure to some other environmental parameter (e.g., temperature) or process condition, may make it conducting enough to provide sufficient electrical conductivity to provide a reasonable capacitive or electric field based measurement. Thus, the electrodes themselves do not have to be a metal. Intermediate and other self monitoring coatings, or embedded state sensitive material layers, as described in U.S. patent application Ser. No. 10/441,976, dated May 20, 2003, and Ser. No. 10/937,105, dated Sep. 8, 2004, the entire contents of which are incorporated herein by reference, can be used to enhance any of these modes of sensing. Examples of this include magnetizable coatings whose permeability changes with stress and temperature for magnetic field sensors or coatings whose conductivity changes significantly with temperature, such as glass or diamond coatings, for electric field sensors. Note for windings of the magnetic sensors, graphite or other high temperature materials might be used, such as carbon nanotubes or other conducting nanotechnology materials.

The single sided sensors can also be used for assessing interfacial conditions between a coating and a substrate material. This type of assessment can be performed for the purpose of qualifying the coating quality, the coating adhesion to the surface, and the presence of disbonds. Furthermore, this interfacial condition assessment can be used for predicting the likelihood of a disbond occurring. For the above case of a TBC, assessment of interfacial condition may include determining the presence and thickness of a thermally grown oxide that commonly forms at the interface between the ceramic coating and the adjacent metal substrate or bond coat. These oxide coatings are commonly insulating and relatively thin, but the oxide typically has a different dielectric constant than the surrounding air or ceramic top coat so that the oxide thickness and properties can be obtained from dielectric sensor measurements. If the oxide is too thick, there is an increased likelihood of spallation or a disbond of the top coat when the component is placed into service.

For metallic coatings on metallic substrates, magnetic field based MWM and MWM-Array sensors can be used to assess the properties of the substrate and coating and the interfacial conditions. An example is the measurement of the permeability of a ferromagnetic substrate (steel) through a nonferromagnetic layer, i.e., an aluminum alloy coating. As described in U.S. patent application Ser. No. 10/934,103, dated Sep. 3, 2004, the entire contents of which are incorporated herein by reference, stress variations in a ferromagnetic substrate covered by a non-ferromagnetic coating were monitored by a magnetic field sensor placed over the coating surface. Even without an applied load, the stress can vary due, among other factors, to the quality of the bond between the coating and the substrate. Also, differences in the residual stress can arise in areas where the coating is peeling away or has peeled away from the substrate. These variations in the stress or the presence of cracks and disbonds can appear in the effective properties measured with the sensors. This is illustrated in FIGS. 11 and 12 for a metallic aluminum alloy coating on super alloy substrate. FIG. 11 shows a relatively high frequency measurement image, so that the depth of penetration of the magnetic field is relatively shallow compared to the coating thickness, and clearly shows the presence of a crack in the coating. FIG. 12 shows a relatively low frequency measurement image, where the depth of penetration of the magnetic field is long compared to the coating thickness, and both the cracks and disbond areas are apparent.

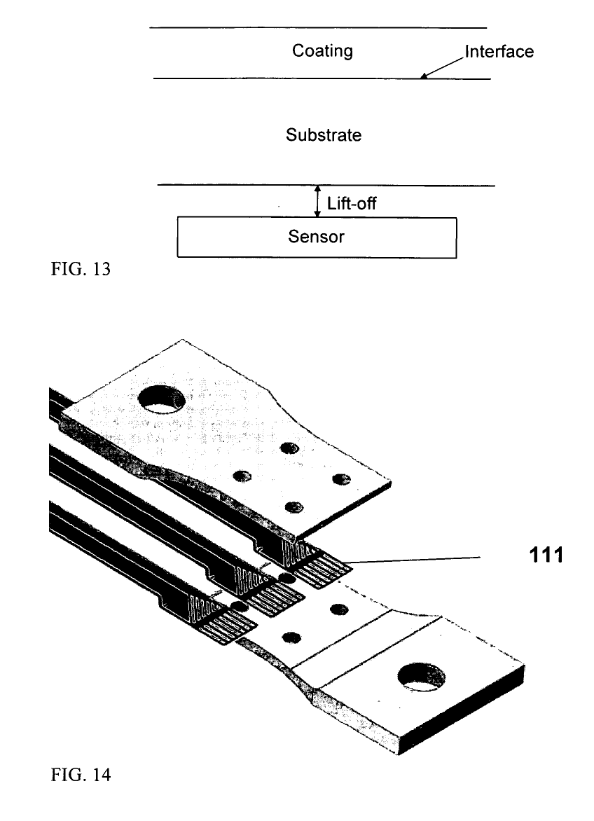

Previous approaches typically had the stress being monitored by a sensor placed on the coating side of the sample. However, that is not always possible because of space limitations or because of excessive coating-side temperatures. Here, the interfacial stress is being monitored by a sensor being placed behind the substrate and can represent, for example, placing the sensor on the outside of an engine housing so that the stresses on a coating or at an interface between layers or within a bondcoat inside the engine can be monitored. This is illustrated in FIG. 13, where the coating is a magnetic metallic bond coat and the substrate is a metal that may or may not also be magnetic. Multiple frequency measurements are used to assess the properties of the various material layers. Typical unknown model parameters to be determined from the measurements are the lift-off, the substrate conductivity and thickness, and the coating permeability. This allows variations in substrate properties to be accounted for, so that the estimates of the coating permeability have minimal contamination from these other factors. It may also be possible to assume values for the substrate conductivity and thickness, either based on apriori knowledge or measurements on other samples. Also, the coating may be magnetizable, but this introduces another unknown, which increases the time required for estimating the parameters and typically reduces the robustness of the estimate. Measurement of the coating permeability then allow the residual stress on the buried or hidden material layer interface to be inferred. In a related filing, U.S. Provisional Application No. 10/441,976 dated May 20, 2003, the entire teachings of which are incorporated herein by reference, the stress on a hidden material layer was monitored through a second material layer and an air gap. Here, the interest is in the interfacial condition between the two material layers.

Another method of assessing the condition of materials on one or both sides of an interface is to place sensors or sensor arrays at the interface. However, then care must be taken to prevent damage to the sensor. This can be accomplished with the use of shims and thin embeddable sensors or sensor arrays mounted between material layers. In some configurations, the mechanical load transferred between the material layers causes fretting damage at the faying surface between the layers. The fretting is made worse when cold working of the fastener holes causes a deformation or volcano near the hole edges. The survivability of sensors placed near or in these fretting regions is then compromised. An embodiment of this invention is to place spacer shims at one or more locations around the sensors that prevent or minimize the fretting on the sensor itself. The shim, which can be made of an insulating material such as a mylar, should be thick enough to account for the thickness of the sensor itself, any adhesive used to attach the sensor to a surface, and any surface deformations, such as the volcanoes. The shim should also be thin enough so that the structural or dimensional integrity of the component is not compromised. Similarly, a self-monitoring magnetizable coating can act as a shim, with or without sensors also providing faying surface stress monitoring. This is very useful for determining where stresses are supported, e.g., faying surface, bolts, bending, etc.

In a related embodiment shims are used not only adjacent the sensor but between the sensor and the surface. By placing an insulting layer or shim (separate from or part of the sensor construct) between the windings and either metal surface, the field interaction is altered. In one embodiment of the invention the shim thickness (between the sensor and metal) is selected to enhance the sensitivity to damage or stress changes in the metal.

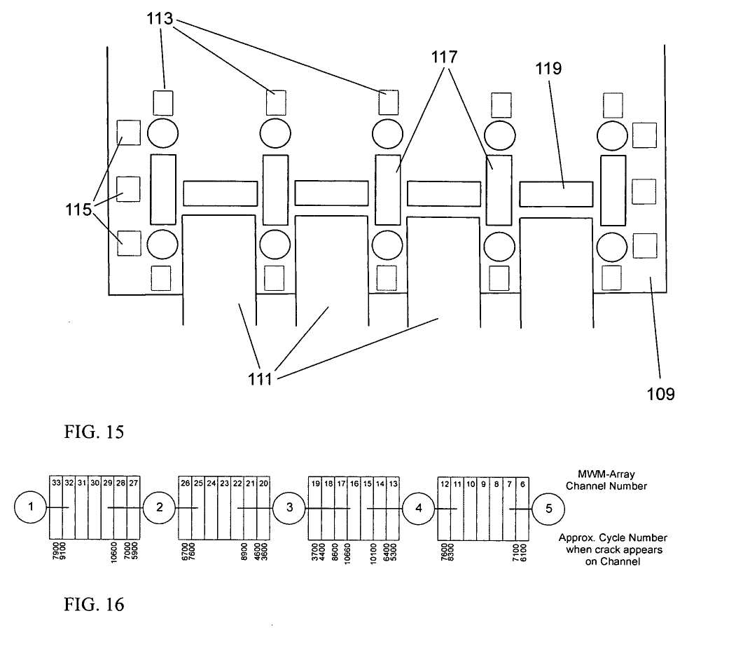

FIG. 14 shows a rendering of a lap joint containing four holes and three sensor arrays (111) mounted along one row of fastener holes. These sensor arrays were sandwiched between two layers of aluminum, with both layers attached by fasteners passed through each hole, and then the joint was cycled to failure. Early stage crack formation and crack propagation between the fastener holes was monitored during the fatiguing process. Sensor arrays also monitored the other row of fastener holes. Similar tests were performed on larger panels having eight MWM®-Arrays mounted on the faying surface between the two test panels. In this case the test panels had two rows of five fastener holes, so the four sensor arrays were required for mounting on the ligaments between each fastener hole for both rows of fasteners. FIG. 15 shows a schematic diagram for this geometry and four of the sensor arrays 111 on a single panel 109. While the primary emphasis was to monitor the ligaments of the test row of fasteners of one panel, a secondary consideration was the desire to monitor any crack development on the non-test row of fasteners. To alleviate the bending moment which caused cracking along the tangents of the fastener holes, stiffening plates were employed. Additionally, the primary and multisite (MSD) EDM notches in the test row were 0.10 and 0.05 inches long and fatigue precracked.

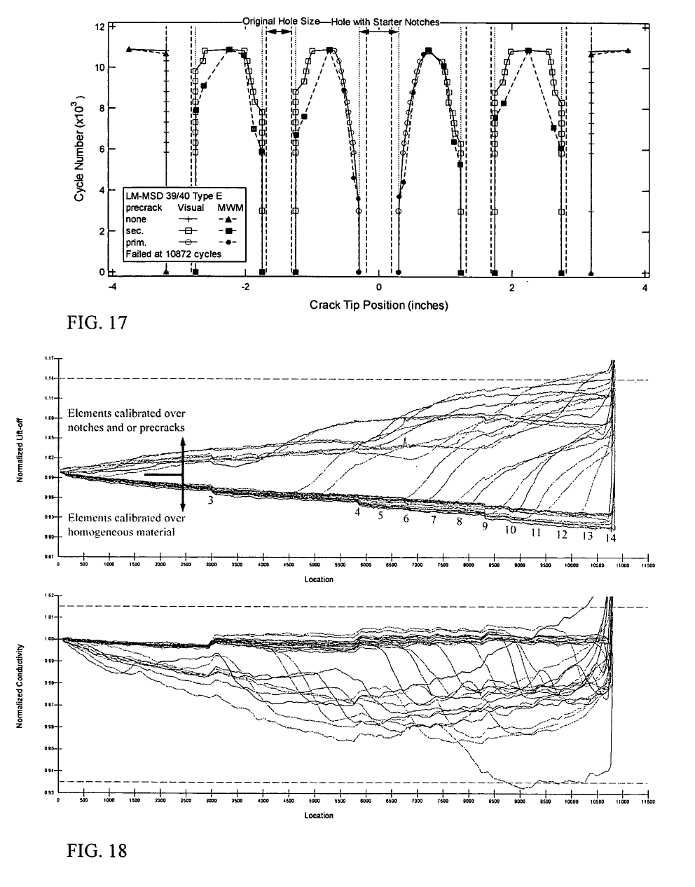

FIG. 16 shows a schematic of the crack growth across the sensor arrays placed over the test row of fastener holes. The channel numbers corresponding to each sense element are indicated. Also indicated is the approximate cycle number where a reduction in effective conductivity, associated with the presence of the crack, becomes apparent. FIG. 17 shows a plot of the crack growth history based on the visual measurements on the exposed surface during testing. After observing the first cracks at approximately 5800 cycles, measurements were taken of all visible cracks every 500 cycles. The cracks were only visible once they came out from under the stiffeners, so that the minimum crack length was at least 0.150 inches. In addition, the Teflon tape place between the stiffener and the specimen material extended slightly past the stiffener edge, so that the minimum length for visual detection was closer to 0.170 inches. The part failed at 10872 cycles. FIG. 17 also shows an estimate of the crack growth history based on the cycle number when the effective conductivity for each sense element is reduced. In this estimate, it was assumed that each sensor array was 0.0395-inches from the edges of each hole and the width of the individual drive winding loops was 0.149 inches. For the edge sense elements that were calibrated on top of the cracks, it was assumed that the cracks had grown 0.010 inches when the effective conductivity started to change. Such a sensor network, with or without shims, configuration could be used with cables going to easy access locations within an aircraft or full scale test article or to a continuous or continual health monitoring unit on-board.

FIG. 15 shows the layout of stand-off shims and some of the sensor arrays on the ten-hole test panel. The shims were cut to four sizes: in millimeters, approximately, 7×7 (113), 7×11 (115), 7×23 (117) and 7×25 (119) on a side. The various sizes were used to provide a better fit into each region around the fastener holes. A sufficient number and size of the shims were used to support the load evenly between the two material layers that comprise the lap joint itself. The goal was to provide support to the joint without having the shims get too close to the holes where the volcanoing or surface deformation was excessive. If shims were placed to close to the holes, the surface would be uneven since the elevation would be affected by the deformation by the holes and the shims could be exposed to fretting damage at the surface. Mylar™ is a representative shim material. The shim thickness was chosen so that the standoff distance was greater than the sensor thickness in addition to the height of the volcanoes caused by the cold working of the fastener holes. Due to the length of the EDM notches and the employment of precracks, the two outer sense elements of each array began the test over the precracks of the test panel. This did not appear to cause a problem with the measurements (although it did alter the response a bit for these outer sense elements). The lapjoint was fatigued at a constant load ratio of 0.1 at 3 Hz. MWM data was acquired every 3.33 seconds (or 10 cycles). The cycling was interrupted periodically so that load ramps could be performed to monitor any changes in the specimen with the strain gauges. Alternatives for shims include sealant or adhesive designed specifically to ensure survivability/operation of the embedded sensors.

FIG. 18 shows a plot of all of the data for each channel, 28 total, monitoring the test row of fasteners. A moving boxcar average was used to smooth the conductivity and lift-off responses and the data for all channels is normalized by the first boxcar-averaged set. In FIG. 18 two long-term features of the test are apparent. First, as the test progressed, the lift-off for all channels steadily declined. This is attributed to the very high bond (VHB) adhesive used to adhere the sensors and stand-off shims to the faying surface. Due to the high loads transferred through the stand-off shims, the VHB flows and reduces the gap between the panel and sensor surface. This effect is exacerbated by the long time period between the last and first fatigue cycle before and after a strain gauge load ramp. The lift-off accumulated during any stoppage in cycling appears as a step in the normalized lift-off (top plot in FIG. 18). A similar trend is apparent in the normalized conductivity (bottom plot in FIG. 18). Due to the heating of the material from fatigue cycling, the conductivity steadily decreases. During the slow load ramps when strain gauge data is acquired, the panel cools and a step increase in conductivity is observed. Similar long term trends were obtained for the non-test row of fasteners, except no crack responses were observed.

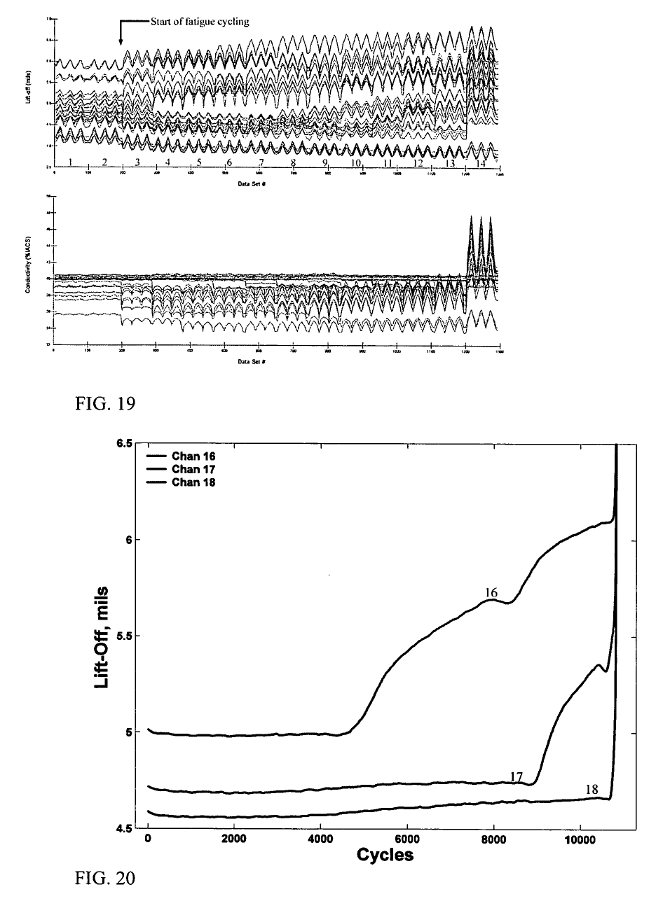

Periodically the test was stopped to perform load ramps that are commonly performed for strain gauge measurements. Note that the strain gauges do not provide meaningful information while the fatigue cycling is being performed. Normalized lift-off and conductivity plots of all data acquired during the strain gauge load ramps for the test row of fasteners is shown in FIG. 19. These plots display the variation of MWM measured effective properties over the course of a load cycle. Notice that the lift-off tracks the load cycle well, indicating the lap joint gap expands and contracts under load. Conversely, the conductivity is steady unless or until a crack is present or extends across a primary winding conductor bordering a sense element. Each ramp consisted of three load-unload cycles. Two load ramps were performed prior to starting the fatigue cycling.

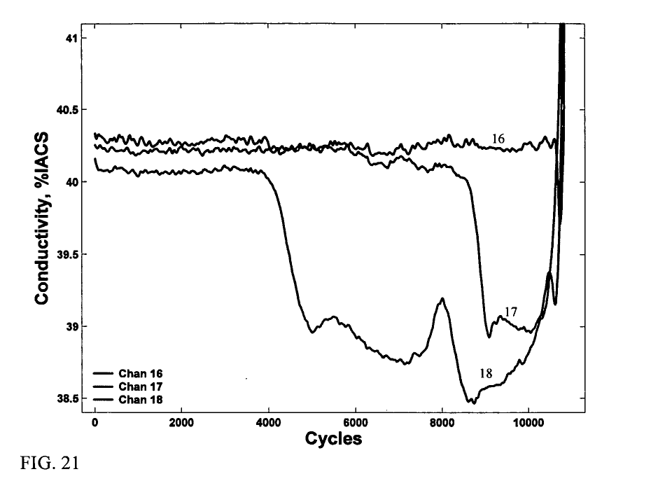

Representative plots for the sense element channels on one side of a fastener hole are shown in FIG. 20 for the lift-off and FIG. 21 for the conductivity. In this case, the data is processed or adjusted to normalize out the determistic factors such as the thermal transients or the lift-off transient associated with the flow of adhesive. This can be done by normalizing the responses using the responses from channels in areas not yet experiencing cracking, by using multiple frequency methods or other methods. The data is then adapted or adjusted for better visual or analytic detection of the crack tip or prediction of crack progression.

Furthermore, from the adapted or adjusted data from FIGS. 20 and 21, it is clear that specific features of the responses discretely indicate when the crack has reached a certain position. One feature is the peak or a sharp change in the conductivity response of the first channel (channel 18) at around 8000 cycles, which occurs right before the second channel (channel 17) begins detecting the presence of the crack. A second feature is the essentially monotonic variation in the sense element or channel response signal as the crack grows across the channel. This allows for a dynamic and continuous estimation of crack growth. The sharp change feature thus allows for discrete measurements of crack tip position while the monotonic change feature allows growth estimates. One embodiment of this invention is to design the sensor windings so that these features are emphasized and positioned appropriately to maximize observability of the anticipated crack growth progression, for a given part configuration.

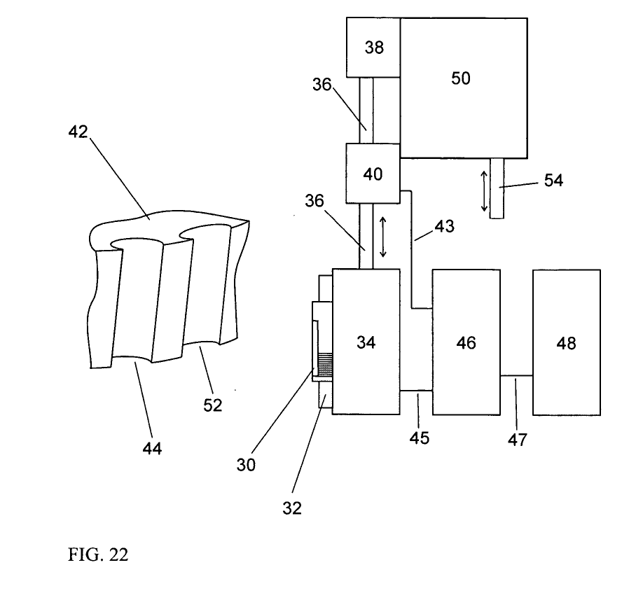

In a related embodiment, the MWM-Array is configured into a probe and fixture that provides a capability to inspect engine disk slots without having to remove the disks from the engine. In this configuration, the inspection fixture is relatively small and compact, allowing it to be mounted near the engine so that once the blades are removed the sensor or sensor array can be scanned though the disk slots to perform the inspection. This is illustrated in FIG. 22. The flexible MWM-Array 30 is placed in the slot 44 of the disk 42 with a support 32. The support can be rigid or can include conformable components such as an inflatable balloon as described in U.S. Pat. No. 6,798,198 and U.S. patent application Ser. No. 10/419,702, filed Apr. 18, 2003, the entire teachings of which are incorporated herein by reference. The inflatable balloon can be filled with water to provide pressure behind the sensor and can improve sensor durability (i.e., by deflating the balloon prior to entry into the slot). The support 32 can be attached to probe electronics 34, which provide amplification of the sense element signals, a shaft 36, which guides the scan direction for the sensor, and a balloon inflation mechanism 38. A position encoder 40 provides longitudinal registration of the MWM-Array data along the axis of the inspected slot. The sensing elements positions (for example with 0.04 in. spacing) provide the position in the transverse direction, resulting in a fully registered two-dimensional image, with manual scanning using an single, axial, position encoder. The electrical signals are monitored with the parallel architecture data acquisition impedance instrumentation 46 through electrical connections from the probe electronics 45 and the position encoder 43. A connection 47 between the impedance instrument and a processor 48, such as a computer, is used to control the data acquisition and process and display the data. The position encoder and balloon inflation mechanism can be held in position by a frame structure 50 that also permits mounting near the engine disk. The frame 50 can also include a guide 54, typically of a plastic material, that can be inserted into a slot 52 near the slot to be inspected (44) to semi-automatically register the probe with respect to the slot to be inspected.

This probe has the capability to inspect both the lower and upper quadrant of the slot on one side in a two step process. The process involves manually pressing a button that conveniently and quickly shifts the encoder configuration to support scanning the bottom quadrant of the slot side beginning at the center and then returning to the center, pressing the button, and scanning the upper quadrant of the slot side. This design requires the operator to flip over the disk to then inspect the upper and lower quadrants of the opposite side of the slots. Alternatively, the MWM-Array can be designed to permit scanning of both sides simultaneously, without flipping over the engine disk, permitting rapid scanning of both sides in either a manual or automated operation. The use of balloons that are deflated upon entry into the slot often extends the life of the sensors by limiting damage upon entry into the slot. Also, combinations of balloons and foam with plastic can often improve conformability to complex slot geometries.

The motion of the inspection probe through the slot can be performed in a manual or semi-automated fashion. Typically, once the probe is aligned with the slot to be inspected (44), a computer can be used to control a guide to register the probe with respect to the inspection slot and also to rotate the engine disk so that each slot can be inspected sequentially using the probe. The actuation of the guide can be done pneumatically. In this fashion, all of the disk slots can be inspected without having to remove the engine disk and to place it on a turntable. Note also that the conversion of the measurement data information into effective properties, such as effective conductivity and effective lift-off, can also be used to assess the quality of the inspection scan. For example, the lift-off values can indicate if the surface is excessively rough, if the probe is too close or too far away from the slot material surface.

While the inventions have been particularly shown and described with reference to preferred embodiments thereof, it will be understood to those skilled in the art that various changes in form and details may be made therein without departing from the spirit and scope of the invention as defined by the appended claims.

1. A method for detecting hidden cracks by a fastener in a material comprising:
disposing a sensor proximate to a test material, the sensor containing a drive conductor for a imposing a field when driven by an electric current and at least one sense element for sensing the field;
passing a time-varying electric current through the drive conductor;
measuring the sense element response as the sensor is scanned over the fastener;
comparing the response to a reference scan and using a threshold value to determine likelihood of crack presence.

2. The method as claimed in claim 1 wherein the fastener is in an aircraft skin.

3. The method as claimed in claim 1 wherein the sensor comprises at least two parallel rows of aligned sense elements, with at least one linear drive conductor segment positioned parallel to and between the sensing element rows for imposing a magnetic field; and having a first row of sensing elements for detecting a crack on one side of the fastener and a second row of sensing elements for detecting cracks on another side of the fastener.

4. The method as claimed in claim 1 further comprising at least two excitation frequencies and using a high frequency response to adjust the threshold value.

5. The method as claimed in claim 1 further comprising determining sensor lift-off and using this lift-off to select an appropriate reference scan for comparison as a shape filter to improve crack detection reliability.

6.-35. (canceled)

36. A method of detecting hidden cracks by a fastener in a material comprising:
disposing a sensor proximate to a test material, the sensor containing a drive conductor for imposing a field when driven by an electric current and at least one sense element for sensing the field;
passing a time varying electric current through the drive conductor;
measuring the sense element response as the sensor is scanned over the fastener;
using the sense element response to determine a reference parameter;
comparing the sense element response to a reference scan to determine likelihood of crack presence.

37. A method as claimed in claim 36 wherein the reference parameter is the peak magnitude of a transinductance.

38. A method as claimed in claim 36 wherein the reference parameter determines fastener type.

39. A method as claimed in claim 36 wherein the reference parameter is used to determine the reference scan.

40. A method as claimed in claim 36 wherein the reference parameter is used to determine a threshold value for the comparison.

41. The method as claimed in claim 36 wherein the fastener is in an aircraft skin.

42. The method as claimed in claim 36 wherein the sensor comprises at least two parallel rows of aligned sense elements, with at least one linear drive conductor segment positioned parallel to and between the sensing element rows for imposing a magnetic field; and having a first row of sensing elements for detecting a crack on one side of the fastener and a second row of sensing elements for detecting cracks on another side of the fastener.

43. The method as claimed in claim 36 further comprising determining sensor lift-off and using this lift-off to select an appropriate reference scan for comparison as a shape filter to improve crack detection reliability.

44. A method as claimed in claim 36 wherein the test material contains at least two material layers.

45. A method as claimed in claim 36 wherein the electric current has at least two excitation frequencies.

46. A method as claimed in claim 45 wherein high and low frequency scan responses are subtracted to provide a sense element response.

47. A method as claimed in claim 1 wherein the reference scan represents a crack.

48. A method as claimed in claim 1 further comprising using a high frequency response to adjust the threshold value.

49. A method as claimed in claim 1 wherein a high frequency measurement is used to determine fastener type.

50. A method as claimed in claim 1 wherein the field is a magnetic field.
